(19) United States
(12) Patent Application Publication
(10) Pub. No.: US 2022/0365105 A1
(43) Pub. Date: Nov. 17, 2022

(54) EQUIPMENT FOR THE CONTROL OF THE INDUSTRIAL CONTAMINATION OF INDUSTRIAL COMPONENTS

(71) Applicant: OILSAFE S.r.l., Modena (IT)

(72) Inventors: Alessandro CAMPI, Modena (IT); Massimo ZOBOLI, Modena (IT)

(73) Assignee: OILSAFE S.r.l., Modena (IT)

(21) Appl. No.: 17/640,396

(22) PCT Filed: Sep. 2, 2020
(86) PCT No.: PCT/IB2020/058165

§ 371 Date: Mar. 4, 2022

(30) Foreign Application Priority Data
Sep. 4, 2019 (IT) 102019000015593

(51) Int. Cl. G01N 35/00; G01N 35/10

(52) U.S. Cl. CPC G01N 35/00029; G01N 35/1004; G01N 2035/00277; G01N 2035/00306; G01N 35/02

(57) ABSTRACT

Equipment for the control of the industrial contamination of industrial components comprising at least one base frame; and an extraction unit/device/component of contaminating impurities from at least one industrial component, mounted on the base frame and provided with a washing unit/device/component of the industrial component by way of an operating fluid adapted to remove the contaminating impurities from said industrial component, the operating fluid mixing with the contaminating impurities to obtain an operating mixture following the washing of the industrial component; and a preparation unit/device/component of at least one analysis sample of the contaminating impurities removed from the industrial component starting from the operating mixture, wherein the equipment comprises an analysis unit/device/component of the analysis sample mounted on the base frame and adapted to detect at least one analytical data which is characteristic of the contaminating impurities.

### TECHNICAL FIELD

The present invention relates to a piece of equipment for the control of the industrial contamination of industrial components.

### BACKGROUND ART

In the field of the industrial production of components for fluid-operated and/or hydraulic apparatuses there is an increasing need to control the degree of industrial contamination of industrial components made by contaminating impurities.

Contaminating impurities consist of solid particles that are present on the surface of an industrial component as a result of its manufacturing process and that can lead to critical issues both during assembly with other equipment and during the operation thereof. Specifically, the contaminating impurities may cause breakages and malfunctions, cause assembly and sealing inconveniences, lead to early clogging of any filters in the equipment, or generate high surface wear.

It follows that the control of industrial contamination is of considerable importance and needs to undergo precise parameters defined by current regulations.

For this purpose, equipment for the control of the industrial contamination is known which allows the extraction of such contaminating impurities from the industrial components for analysis purposes.

The extraction of contaminating impurities is generally carried out by washing the industrial component with a suitable liquid, usually the operating liquid.

After washing, the filtering phase takes place which consists in the deposition of the freshly-extracted particles on a membrane with a certain porosity to form a sample that is then analyzed.

This process does have some drawbacks.

In fact, in order to carry out the analysis it is necessary to use expensive and cumbersome equipment, as well as to rely on experienced and competent staff who is able to correctly process the analytical data collected.

This can be extremely disadvantageous for small production companies with limited resources.

As a result, these companies are forced to contact specialized analysis centers with a significant increase in the time needed to obtain the analytical data and high costs, despite the risk of “human error” in data processing.

In addition, the transfer of the sample to such analysis centers can lead to contamination of the sample itself by the external environment and thus to unreliable analytical data.

### DESCRIPTION OF THE INVENTION

The main aim of the present invention is to devise a piece of equipment for the control of the industrial contamination of industrial components that allows analyzing the contaminating impurities of an industrial component in a precise and reliable way.

Within this technical aim, one object of the present invention is to allow reducing the time and costs related to the execution of the analysis of samples.

Furthermore, one object of the present invention is to devise a piece of equipment for the control of the industrial contamination of industrial components that allows drastically reducing the risk of “human error” in the analysis of samples and related operations.

Another object of the present invention is to allow an effective extraction of the contaminating impurities in order to obtain reliable and representative samples of analysis.

A further object of the present invention is to devise a piece of equipment for the control of the industrial contamination of industrial components that allows eliminating the risks related to the possible contamination of the sample of analysis by the external environment.

Another object of the present invention is to devise a piece of equipment for the control of the industrial contamination of industrial components that allows overcoming the above mentioned drawbacks of the prior art within a simple, rational, easy, effective to use and affordable solution.

The objects set forth above are achieved by the present piece of equipment for the control of the industrial contamination of industrial components having the characteristics of claim 1.

### BRIEF DESCRIPTION OF THE DRAWINGS

Other characteristics and advantages of the present invention will be more evident from the description of a preferred, but not exclusive, embodiment of a piece of equipment for the control of the industrial contamination of industrial components, illustrated by way of an indicative, yet non-limiting example, in the attached tables of drawings in which:

FIG. 1 is an axonometric view of a piece of equipment for the control of the industrial contamination of industrial components according to the invention;

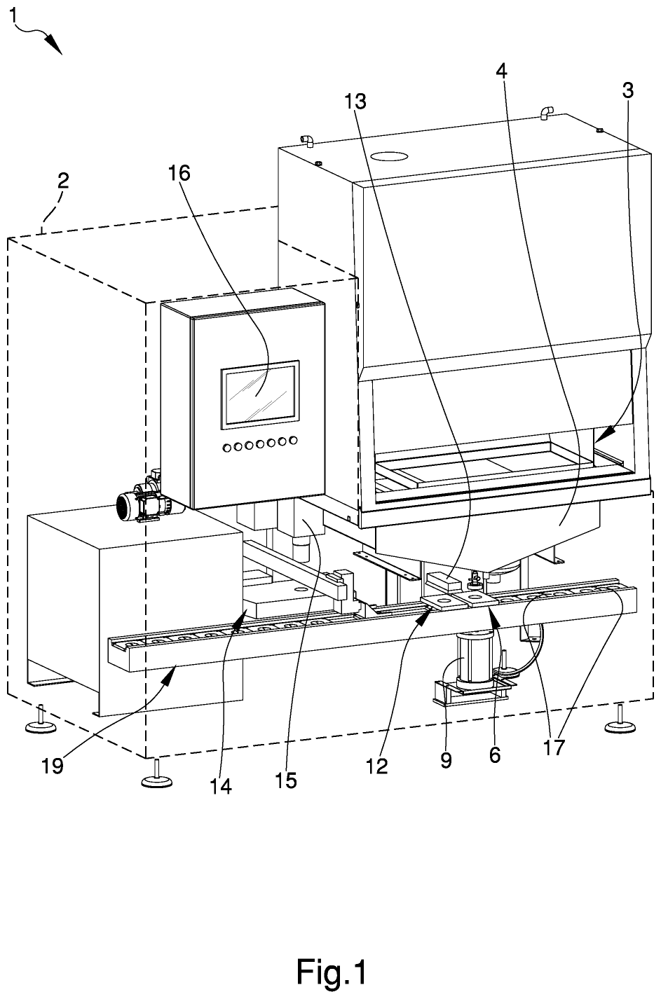

FIG. 2 is an axonometric view of the equipment components according to the invention;

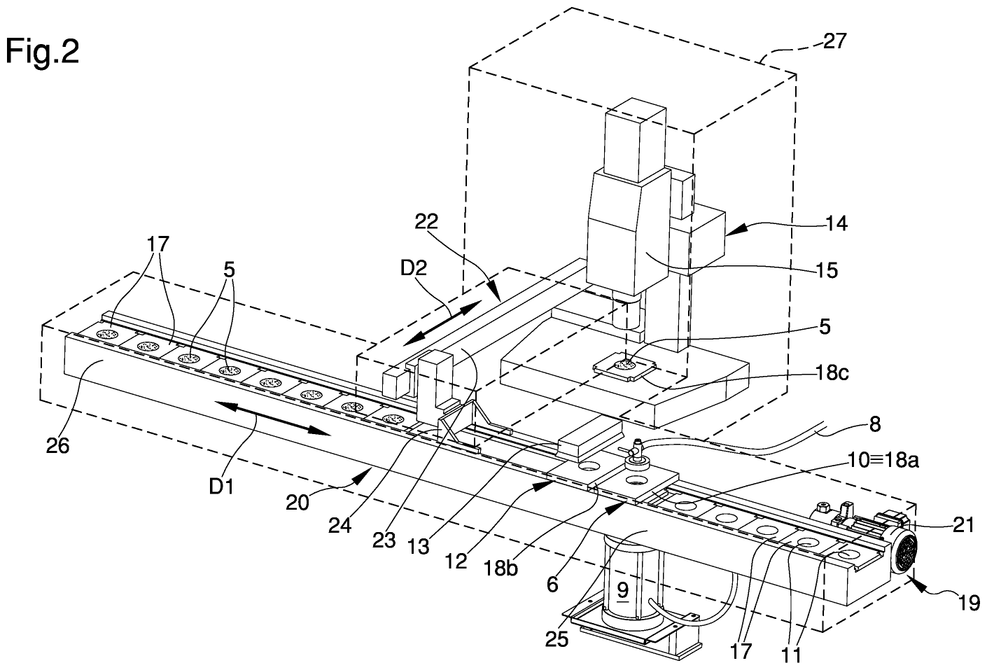

FIG. 3 shows an operating diagram of the equipment according to the invention.

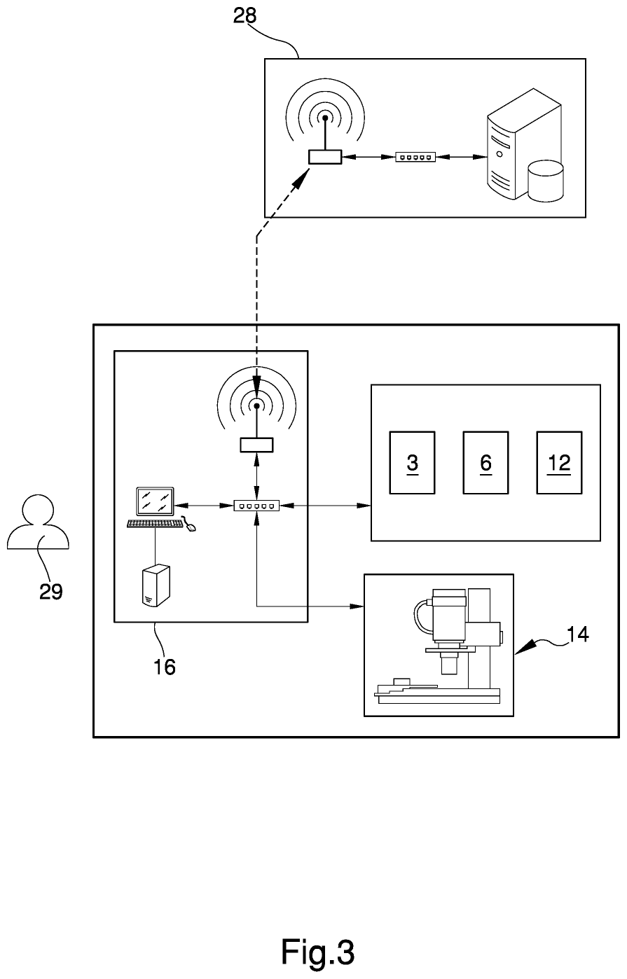

### EMBODIMENTS OF THE INVENTION

With particular reference to these figures, reference numeral 1 globally indicates a piece of equipment for the control of the industrial contamination of industrial components.

The equipment 1 comprises at least one base frame 2 and extraction means 3, 6, 12 for extracting contaminating impurities from at least one industrial component, mounted on the base frame 2.

In the context of the present discussion, the term “industrial component” means an industrial component intended to be used in equipment for the transport of a fluid, e.g. a hydraulic pipe, or which operate through the use of an operating fluid, or which, in any case, require a precise control of the level of industrial contamination (e.g. screws, gears, shafts, bearings, etc.). As a result of their manufacture, these industrial components may have contaminating impurities, represented e.g. by machining residues or atmospheric dust, which must be controlled and fall within certain parameters, in order to establish the suitability for use of the industrial components themselves.

The extraction means 3, 6, 12 are provided with washing means 3 of the industrial component by means of a work liquid adapted to remove the contaminating impurities from the industrial component.

The work liquid is selected from water, oil, a solvent or a mixture thereof.

Appropriately, the work liquid is a liquid compatible with the operating fluid.

Advantageously, the washing means 3 comprise injection means adapted to inject the work liquid inside or outside the industrial component and defining at least one washing line.

In particular, the washing line comprises at least one inflow portion and at least one outflow portion of the work liquid wherein the industrial component is connectable in a fluid-operated manner to the washing line between the inflow portion and the outflow portion.

Conveniently, the washing line generates turbulence in the work liquid inside the industrial component to remove the contaminating impurities.

In fact, fluxing the work liquid with high turbulence allows the work liquid to reach every point of the industrial component and thus allows removing contaminating impurities more effectively.

The washing line also allows precisely adjusting the injection pressure of the work liquid based on the characteristics of the industrial component to be controlled.

In addition, further embodiments of the equipment 1 cannot be ruled out wherein the injection means comprise a dispensing gun that can be possibly used in combination with the washing line for washing the industrial component.

In particular, the use of the dispensing gun facilitates washing the external surfaces of the industrial component.

After washing the industrial component, the work liquid is mixed with the aforementioned contaminating impurities to obtain a work mixture.

The work mixture is, therefore, a heterogeneous mixture consisting of the contaminating particles suspended in the work liquid.

The washing means 3 may also comprise collecting means 4 of the work mixture.

The extraction means 3, 6, 12 are provided with preparation means 5 of at least one analysis sample 5 of the contaminating impurities removed from the industrial component from the work mixture.

The contaminating impurities need, in fact, to be isolated from the work liquid in order to be analyzed later.

Appropriately, the preparation means 6, 12 comprise filtration means 6 of the work mixture which are connected in a fluid-operated manner to the washing means 3 and adapted to separate the contaminating impurities from the work liquid in order to obtain the analysis sample 5.

The preparation means 6, 12 also comprise drying means 12 adapted to dry the analysis sample 5.

In order to carry out the analysis, in fact, the sample must be dried, so that any residues of work liquid do not interfere with the analysis.

Advantageously, the drying means 12 comprise at least one radiation emitting device 13 adapted to dry the analysis sample 5 by irradiation.

In the present case, the radiation emitting device is selected from infrared lamp, UV lamp, or any other device suitable for this purpose.

Conveniently, the equipment 1 comprises at least one suction assembly 9 of the work mixture, which can be connected in a fluid-operated manner to at least one of either the filtration means 6 or the drying means 12.

For this purpose, the suction assembly 9 comprises two connecting lines, one connected in a fluid-operated manner to the filtration means 6 and another connected in a fluid-operated manner to the drying means 12.

The suction assembly 9 comprises a vacuum pump, or a similar device, which allows optimizing the timing related to the filtration and drying operations.

The filtration means 6 also comprise at least one collecting line 8 of the work mixture connected in a fluid-operated manner between the washing means 3 and the suction assembly 9.

In particular, the collecting line 8 may be connected to the collecting means 4 or, alternatively, directly to the washing line.

In addition, the filtration means 6 comprise at least one housing compartment 10 of at least one filtering element 11 positioned along the collecting line 8 between the washing means 3 and the suction assembly 9.

The filtering element 11 retains the contaminating impurities from the work liquid to obtain the analysis sample 5.

The filtering element is of the type of a filtering membrane, of the type known to the technician in the sector, compatible with the work liquid and having such a porosity to retain entirely on its surface the contaminating impurities present in the work mixture.

According to the invention, the equipment 1 comprises analysis means 14 of the analysis sample 5 mounted on the base frame 2 and adapted to detect at least one analytical data which is characteristic of the contaminating impurities.

In other words, the extraction means 3, 6, 12 and the analysis means are mounted on an individual machine, so that the analysis sample 5 can be analyzed as soon as it is obtained and provide an analytical data in an extremely quick and reliable manner.

Conveniently, the analysis means 14 comprise at least one detecting device 15 of the analysis sample 5 adapted to detect the analytical data.

The detecting device 15 is of the type of an electronic microscope.

In this regard, it should be noted that the term “analytical data” means a raw data detected by the detecting device 15 and able to provide information which is characteristic of the contaminating impurities. The analytical data is, e.g., a numerical data related to the number and size of the particles that make up the contaminating impurities present in the industrial component, the images related to the contaminating impurities, the position of the contaminating impurities for possible in-depth analysis, such as discrimination between glossy (e.g. metals) or opaque (e.g. elastomer) contaminating impurities as well as targeted analysis with 3D readings of the individual contaminating impurities.

Advantageously, the equipment 1 comprises at least one programmable electronic unit 16 comprising at least one processing unit configured to process at least one analytical data depending on at least one predefined parameter to obtain at least one processed analytical data.

The programmable electronic unit 16 is configured to process the analytical data depending on the above mentioned predefined parameters, related, e.g., to the type of industrial component to be controlled, the size of the industrial component, the volume of work liquid used, the flow rate, the time spent, etc., in order to generate processed analytical data that can be compared to each other and representative of the controlled industrial component.

The programmable electronic unit 16 also comprises at least one storage unit adapted to store at least one of either the at least one analytical data and the at least one processed analytical data.

The storage unit can also store the predefined parameters.

The programmable electronic unit 16 is also configured to be connected to a remote control unit 28 which is, in turn, configured to display, allow processing and/or store the analytical data and the processed analytical data through a remote device by an operator 29.

Preferably, the remote device is an electronic device, e.g. of the type of a server, a PC or the like.

In the embodiment shown in the figures, the equipment 1 comprises a movable support 17 intended to accommodate the analysis sample 5.

The movable support 17 has the function to allow the easy displacement of the analysis sample 5 between the filtration means 6, the drying means 12 and the analysis means 14.

The movable support 17 is of the type of a plate, on which the filtering element 11 is placed, the plate being provided with a hole through which the work liquid can flow during the filtration operation.

Appropriately, each of the filtration means 6, drying means 12 and analysis means 14 comprises a respective housing location 18a, 18b, 18c which is shaped so as to receive the movable support 17.

In particular, the housing location 18a of the filtration means 6 coincides with the housing compartment 10.

In more detail, the housing location 18a is shaped so as to connect the movable support 17 to the suction assembly 9 and to the collecting line 8 in an air-tight manner. The housing location 18b of the drying means 12 is shaped so that the movable support 17 is housed below the radiation emitting device 13.

The housing location 18c of the analysis means 14 is shaped in such a way that the movable support 17 is housed at the point where the detecting device 15 is located.

Advantageously, the equipment 1 comprises movement means 19 of the movable support 17 along a direction of forward movement D1 along which the filtration means 6, the drying means 12 and the analysis means 14 are arranged in succession.

The movement means 19 comprise a guidance unit 20 that extends along the aforementioned direction of forward movement D1 and means of transport which are adapted to move the movable support 17 along the guidance unit 20.

In particular, the means of transport may be of the type of a conveyor belt, a roller conveyor, or the like.

The movement means 19 also comprise a motor assembly 21 which is responsible for the operation of the means of transport.

The analysis means 14 conveniently comprise transfer means 22 adapted to transfer the movable support 17 between an analysis position, wherein the analysis sample 5 is placed at the detecting device 15 in the respective housing location 18c, and a sliding position, wherein the movable support 17 is placed at the movement means 19 along the direction of forward movement D1.

The transfer means 22 have the function to correctly position the analysis sample 5 at the point where the detecting device 15 is located to perform the analysis operation.

The transfer means 22 comprise at least one arm 23 associated with the detecting device 15, which extends along a direction of transfer D2, substantially transverse to the direction of forward movement D1, and gripping means 24 of the movable support 17 associated movable with the arm 23 and movable along the direction of transfer D2 to displace the movable support 17 between the analysis position and the sliding position.

Advantageously, the equipment 1 comprises a plurality of movable supports 17 and the movement means 19 comprise a loading section 25 of the movable supports 17 placed upstream of the filtration means 6 and adapted to transport the movable supports 17 towards the filtration means 6.

This way, the guidance unit 20 is able to accommodate the plurality of movable supports 17 and allows the equipment 1 to carry out a plurality of analysis operations in series, freeing itself from the need to manually load the movable support 17 for each industrial component to be checked, both for the actual analysis and for the calibration phase of the equipment 1, the so-called “blank”.

Conveniently, the movement means 19 comprise a collecting section 26 positioned downstream of the analysis means 14 and adapted to transport the movable supports 17 away from the analysis means 14.

After being analyzed, in fact, the movable supports 17 are placed back on the guidance unit 20 and moved away from the analysis means 14 to allow the disposal or storage of the analysis samples 5.

The equipment 1 advantageously comprises at least one controlled atmosphere operating chamber 27, wherein at least the preparation means 6, 12 and the analysis means 14 are at least partly housed.

Appropriately, the movement means 19 are also at least partly housed inside the operating chamber 27.

More in detail, the operating chamber 27 is a positive pressure chamber, which has the function to minimize the contamination of the analysis samples 5 by the particles normally present in the environment.

This way, the equipment 1 allows carrying out an extremely accurate and reliable industrial contamination analysis.

Advantageously, the programmable electronic unit 16 is operationally connected and configured to control at least one of either the washing means 3, the preparation means 6, 12, the analysis means 14 or the movement means 19.

The programmable electronic unit 16 is configured to synchronize and coordinate the operation of the different components of the equipment 1.

The operation of the equipment 1 according to the present invention is as follows.

The loading section 25 of the guidance unit 20 is first loaded with at least one movable support 17 provided with the filtering element 11.

The movable support 17, provided with the filtering element 11, is loaded in the loading section 25 of the guidance unit 20.

The programmable electronic unit 16 is programmed by the operator 29 with the predefined parameters, based on the characteristics of the industrial component to be controlled.

The industrial component is then connected to the washing line between the inflow portion and the outflow portion.

At this point, the programmable electronic unit 16 operates the injection means, which inject the work liquid into the industrial component and generate turbulence in the work liquid suitable for removing the contaminating impurities.

The resulting work mixture is collected inside the collecting means 4 and then conveyed to the filtration means 6.

The programmable electronic unit 16 operates on the movement means 19, which transfer the movable support 17 along the loading section 25 towards the respective housing location 18a of the filtration means 6.

The programmable electronic unit 16 operates the filtration means 6 and the work mixture is filtered through the filtering element 11 so that the contaminating impurities are retained on the surface of the latter to provide the analysis sample 5.

The movable support 17 is then transferred towards the drying means 12 in the respective housing location 18b to allow the analysis sample 5 to dry.

The movable support 17 is then transported to the analysis means 14.

The programmable electronic unit 16 operates the analysis means 14 and the transfer means 22 transfer the movable support 17 to the respective housing location 18c, at the point where the detecting device 15 is located to carry out the analysis operation.

The detecting device 15 generates at least one analytical data and sends it to the processing unit for processing the analytical data itself according to the predefined parameters previously set.

The processing unit generates a processed analytical data representative of the contaminating impurities present in the controlled industrial component.

Finally, the transfer means 22 transfer the movable support 17 from the analysis position to the sliding position where the movement means 19 transport it towards the collecting section 26.

It has in practice been ascertained that the described invention achieves the intended objects and in particular the fact is emphasized that the equipment for the control of the industrial contamination of industrial components allows analyzing the contaminating impurities of an industrial component in a precise and reliable manner, thus drastically reducing the risk of “human error” in carrying out the analysis and processing the analytical data, compared to the equipment of known type.

The presence of integrated analysis means and of the programmable electronic unit allows controlling/coordinating/processing in an automated manner all the components of the equipment according to the invention.

In addition, the injection means allow reaching the values of turbulence in the work fluid recommended by the international reference standards, optimizing the extraction of the contaminating impurities from the industrial component and ensuring the acquisition of the analytical data in line with reality.

The equipment according to the present invention allows, moreover, reducing the time and costs related to the execution of the analysis of samples.

Finally, the equipment for the control of the industrial contamination of industrial components allows eliminating the risks related to the possible contamination of the analysis sample by the external environment, thus ensuring reliable analytical results.

1) Equipment for the control of the industrial contamination of industrial components, said equipment comprising:
at least one base frame; and
extraction means of contaminating impurities from at least one industrial component, mounted on said base frame and provided with:
washing means of said industrial component by means of an operating fluid adapted to remove said contaminating impurities from said industrial component, said operating fluid mixing with said contaminating impurities to obtain an operating mixture following the washing of said industrial component;
preparation means of at least one analysis sample of said contaminating impurities removed from said industrial component starting from said operating mixture; and
analysis means of said analysis sample mounted on said base frame and adapted to detect at least one analytical data which is characteristic of said contaminating impurities.

2) The equipment according to claim 1, wherein said analysis means comprise at least one detecting device of said analysis sample adapted to detect said analytical data.

3) The equipment according to claim 1, wherein said washing means comprise injection means adapted to inject said operating fluid in said industrial component and defining at least one washing line comprising at least one inflow portion and at least one outflow portion wherein said industrial component is connectable in a fluid-operated manner to said washing line between said inflow portion and said outflow portion, said washing line generating turbulence in said operating fluid inside said industrial component to remove said contaminating impurities.

4) The equipment according to claim 1, wherein said preparation means comprise filtration means of said operating mixture which are connected in a fluid-operated manner to said washing means and adapted to separate said contaminating impurities from said operating fluid in order to obtain said analysis sample.

5) The equipment according to claim 1, wherein said preparation means comprise drying means adapted to dry said analysis sample.

6) The equipment according to claim 5, wherein said drying means comprise at least one radiation emitting device adapted to dry said analysis sample by irradiation.

7) The equipment according to claim 5, further comprising: at least one suction assembly of said operating mixture, which can be connected in a fluid-operated manner to at least one of said filtration means or said drying means.

8) The equipment according to claim 7, wherein said filtration means comprise:
at least one collecting line of said operating mixture connected in a fluid-operated manner between said washing means and said suction assembly;
at least one housing compartment of at least one filtering element positioned along said collecting line between said washing means and said suction assembly, said filtering element retaining said contaminating impurities from said operating fluid to obtain said analysis sample.

9. The equipment according to further comprising: at least one movable support intended to accommodate said analysis sample and by the fact that each of said filtration means, said drying means and said analysis means comprises a respective housing location suitably shaped so as to receive said movable support, said housing location coinciding with said housing compartment.

10) The equipment according to claim 1, further comprising: movement means of said at least one movable support along a direction of forward movement along which said filtration means, said drying means and said analysis means are arranged in succession.

11) The equipment according to claim 10, wherein said analysis means comprise transfer means adapted to transfer said movable support between an analysis position, wherein said analysis sample is placed in correspondence of said detecting device, in the respective housing location, and a sliding position, wherein said movable support is placed in correspondence of said movement means along said direction of forward movement.

12) The equipment according to claim 1, further comprising: a plurality of said movable supports and by the fact that said movement means comprise a loading section of said movable supports placed upstream of said filtration means and adapted to transport said movable supports towards said filtration means.

13) The equipment according to claim 12, wherein said movement means comprise a collecting section placed downstream of said analysis means and adapted to transport said movable supports away from said analysis means.

14) The equipment according to claim 1, further comprising: at least one controlled atmosphere operating chamber, within which at least said preparation means and said analysis means are at least partly housed.

15) The equipment according to claim 1, further comprising: at least one programmable electronic unit, operationally connected to at least one of said washing means, said preparation means, said analysis means and said movement means:
at least one processing unit configured to process said at least one analytical data according to at least one predefined parameter to obtain at least one processed analytical data; and
at least one storage unit adapted to store at least one of said at least one analytical data and said at least one processed analytical data.

16. Equipment for the control of the industrial contamination of industrial components, said equipment comprising:
at least one base frame; and
a tangible extracting device configured and/or programmed to extract contaminating impurities from at least one industrial component, mounted on said base frame and provided with:
a tangible washing device configured and/or programmed to wash said industrial component by via an operating fluid adapted to remove said contaminating impurities from said industrial component, said operating fluid mixing with said contaminating impurities to obtain an operating mixture following the washing of said industrial component;
a tangible preparation device configured and/or programmed to prepare at least one analysis sample of said contaminating impurities removed from said industrial component starting from said operating mixture; and
a tangible analyzer configured and/or programmed to analysis of said analysis sample mounted on said base frame and adapted to detect at least one analytical data which is characteristic of said contaminating impurities.
